(19) United States
(12) Patent Application Publication
(10) Pub. No.: US 2014/0009513 A1
(43) Pub. Date: Jan. 9, 2014

(54) VIDEO DISPLAY DEVICE AND A TELEVISION RECEIVER

(71) Applicants: Tomoharu Noutoshi, Osaka-shi (JP); Takashi Kanda, Osaka-shi (JP); Toshiyuki Fujine, Osaka-shi (JP)

(72) Inventors: Tomoharu Noutoshi, Osaka-shi (JP); Takashi Kanda, Osaka-shi (JP); Toshiyuki Fujine, Osaka-shi (JP)

(73) Assignee: SHARP KABUSHIKI KAISHA, Osaka-shi, Osaka (JP)

(21) Appl. No.: 14/006,531

(22) PCT Filed: Nov. 30, 2011
(86) PCT No.: PCT/JP2011/077605

§ 371 Date: Sep. 20, 2013

(30) Foreign Application Priority Data
Apr. 7, 2011 (JP) 2011-085514

(51) Int. Cl. G09G 5/10

(52) U.S. Cl. CPC G09G 5/10
USPC 345/690

(57) ABSTRACT

A portion of a video signal for emitting light is detected, and the display brightness of the light emission portion is enhanced and displayed in a more conspicuous manner, whereby the sense of radiance is increased and the image quality is improved. A light emission detector (2) of the video display device generates a histogram in which the number of pixels is integrated into a predetermined feature quantity of an input video signal; and detects an upper region of a predetermined range of the histogram as a light emission section. An area-active control/brightness stretch portion (4) stretches and boosts the brightness of a backlight portion (6). A mapping portion (3) reduces the brightness of the video signal in a non-light-emission section, which excludes the detected light emission section. An increase in the screen brightness of the non-light-emission section is thereby suppressed, and the display brightness of the light emission section is enhanced.

### TECHNICAL FIELD

The present invention relates to a video display device and a television receiver, and more particularly to a video display device and a television receiver provided with an enhancement, function for improving image quality of a display video.

### BACKGROUND OF THE INVENTION

An enhancement function included in a video display device has been known for improving image quality of a display video. In the case of executing the enhancement function, typically, a maximum value of a tone for each frame of a video signal is detected to apply a gain to a part of the video signal with a high tone for expanding the video signal in the case of having a low level of the maximum value, while a minimum value of a tone of the video signal is detected to apply a compression gain to a part of the video signal with a low tone for lowering the tone in a case where the minimum value is high. Using such the enhancement function allows a signal range of a video signal to be wider so that contrast sensitivity of a display image is increased, resulting in improvement in image quality.

For example, Patent Literature 1 discloses a liquid crystal display device for automatically adjusting contrast, along with adjustment of luminance of a backlight, so that contrasting of an image closes to that before the adjustment. The liquid crystal display device is configured to change luminance of an image by turning on/off a light source of a backlight device by an operator so as to allow electricity to be effectively saved, and since an enhancement function works according to the changed luminance to adjust a display image with contrast corresponding to the changed luminance, attain almost the same level of contrast in an image as that before lowering luminance even in the case of lowering luminance of the backlight device.

### PRIOR ART DOCUMENT

### Patent Documents

Patent Document 1: Japanese Laid-open Patent Publication No. 9-80378

### SUMMARY OF THE INVENTION

### Problem To Be Solved By the Invention

In the case of enhancing display luminance, a bright and brilliant light emitting part on a screen is specified to enhance display luminance of the light exalt ting part, thereby improving contrast sensitivity perceived by the human eye, so that a high-definition display video with increased brilliance can be provided.

Processing with a conventional enhancement function is performed that, according to a maximum value or a minimum value in pixel values of a video signal, each of which is high has a tone expanded to be raised while each of which is low has a tone compressed to be lowered. However, since a standardized video signal does not represent luminance actually perceived bright by the human eye, it is difficult to specify a light emitting part only from a tone value. That is, even in the case of evenly enhancing various videos according to a maximum value or a minimum value of pixel values, a high-quality video with high contrast is not necessarily obtained at all times.

The present invention has a benefit that, in widely variable videos, a relatively bright light emitting part is detected from distributed luminance of a video to consciously enhance the light emitting part so that the light emitting part is further emphasized on a screen to improve image quality, however, a conventional technique has not included enhancement function processing performed based on such an idea.

The present invention has been devised in light of the above-described problem, and an object of the present invention is to provide a video display device and a television receiver for detecting a light emitting part of a video signal to enhance display luminance of the light emitting part for emphasized display, thereby representing a video with high contrast having further increased brilliance so as to improve video quality.

### Means For Solving the Problem

To solve the above problems, a first technical means of the present invention is a video display device, comprising: a display portion for displaying an input video signal; a light source for illuminating the display portion; and a controller for controlling the display portion and the light source, wherein the controller detects, based on a histogram of a predetermined feature quantity of the input video signal, an upper area in a predetermined range of the histogram, and enhances display luminance of the upper area in the predetermined range by stretching luminance of the light source to be increased and lowering luminance of a video signal in areas excluding the upper area in the predetermined range.

A second technical means is the video display device of the first technical means, wherein the controller divides an image generated from an input video signal into a plurality of areas, changes a lighting rate of an area of the light source based on a tone value of a video signal in the divided area, and stretches the luminance of the light source based on an average lighting rate of all the areas.

A third technical means is the video display device of the second technical means, wherein the controller defines in advance a relation between the average lighting rate and possible maximum luminance on a screen of the display portion, and stretches the luminance of the light source based on the maximum luminance defined according to the average lighting rate.

A fourth technical means is the video display device of the first technical means, wherein the controller by counting the number of pixels to each of which brightness is weighted for a video in a predetermined range including the detected upper area in the predetermined range, thereby calculates a score indicating a degree of brightness, and stretches the luminance of the light source according to the score.

A fifth technical means is the video display device of any one of the first to the third technical means, wherein the controller determines an area which is greater than or equal to thresh=A+No (N is a constant) as the upper area in the predetermined range, when A is an average value and a is a standard deviation of the histogram, respecting.

A sixth technical means is the video display device of any one of the first to the fifth technical means, wherein the controller reduces an increase in display luminance of the display portion due to a stretch of luminance of the light source according to a decrease in luminance of the video signal in a predetermined area where the feature quantity is low.

A seventh technical means is a television receiver including the video display device of any one of the first to the sixth technical means.

### Effect of the Invention

With the video display device according to the present invention, it is possible to provide a video display device and a television receiver for detecting a light emitting part of a video signal to enhance display luminance of the light emitting part for emphasized display, thereby representing a video with high contrast having further increased brilliance so as to improve video quality.

### BRIEF DESCRIPTION OF DRAWINGS

FIG. 1 is a diagram explaining one embodiment of a video display device according to the present invention, showing a partial configuration of the video display device.

FIG. 2 is a diagrams for explaining a processing example of an area active control/luminance stretch portion.

FIG. 3 is a diagrams showing an example of a Y histogram generated from a luminance signal Y of input video signals.

FIG. 4 is a diagram showing an example of a tone map generated by a mapping portion.

FIG. 5 is a diagram for explaining Max luminance output from the area active control/luminance stretch portion.

FIG. 6 is a diagram showing a state where screen luminance is enhanced through processing by the area active control/luminance stretch portion.

FIG. 7 is a diagram explaining another embodiment of the video display device according to the present invention.

FIG. 8 is a diagram showing an example of a histogram generated from a luminance signal of input video signals.

FIG. 9 is a diagram showing a setting example of luminance stretches according to pixels which are greater than or equal to a third threshold.

FIG. 10 is a diagram explaining still another embodiment of the video display device according to the present invention.

FIG. 11 is a diagram explaining a method of calculating a CMI from a broadcast video signal to be displayed on the video display device.

FIG. 12 is a diagram explaining an optimal color in pixels having RGB data.

### PREFERRED EMBODIMENT OF THE INVENTION

### Embodiment 1

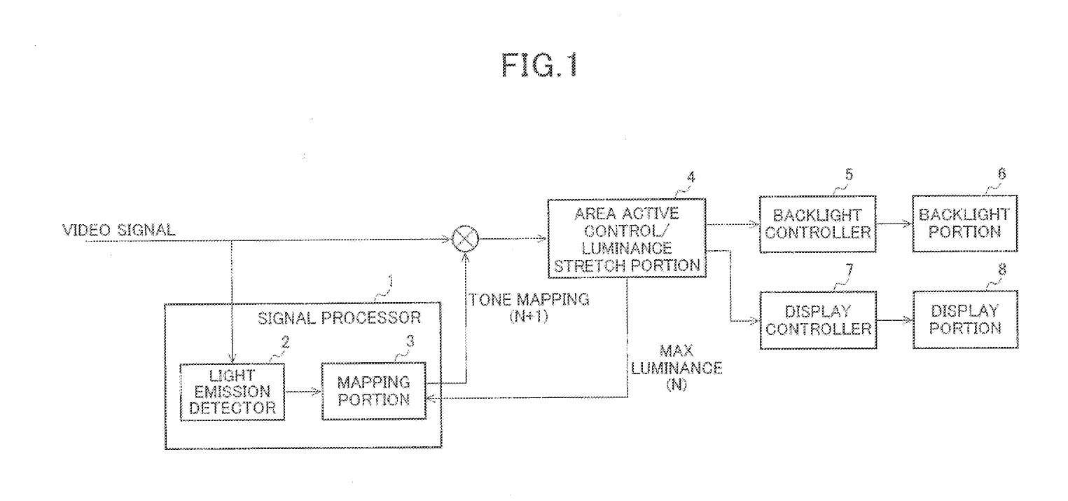

FIG. 1 is a diagram explaining one embodiment of a video display device according to the present invention, showing a partial configuration of the video display device. The video display device is configured to display a video by applying image processing to an input video signal, and can be applied to a television receiver and the like.

A video signal separated from a broadcast signal or a video signal input from an external device is input to a signal processor 1 and an area active control/luminance stretch portion 4. At the time, the video signal input to the area active control/luminance stretch portion 4 is subjected to processing with a tone map generated by a mapping portion 3 of the signal processor 1, and thereafter input to the area active control/luminance stretch portion 4.

The area active control/luminance stretch portion 4 divides an image generated from a video signal into predetermined areas according to the input video signal to extract a maximum tone value of the video signal for each of the divided areas. A lighting rate of a backlight portion 6 is then calculated based on the maximum tone value. The lighting rate is decided for each of areas of the backlight portion 6 corresponding to a divided area of a video. Further, the backlight portion 6 is composed of a plurality of LEDs, and capable of controlling luminance for each area.

The lighting rate for each area of the backlight portion 6 is decided based on a predefined operation expression, however is decided by operating in such a way as to keep luminance of an LED without being lowered basically in a bright high-tone area with a maximum tone value while lowering luminance of an LED in a dark low-tone area.

Then, the area active control/luminance stretch portion 4 calculates an average lighting rate of the entire backlight portion 6 from a lighting rate of each area, and according to the average lighting rate, calculates an amount of luminance stretches of the backlight portion 6 using a predetermined operation expression. Thereby, a possible maximum luminance value (Max luminance) is obtained in an area within a screen. The obtained Max luminance is output to the mapping portion 3 of the signal processor 1.

A light emission detector 2 of the signal processor 1 generates a histogram for each frame based on a feature quantity of an input video signal to detect a light emitting part. The light emitting part is acquired from an average value and a standard deviation of the histogram, and detected as a relative value for each histogram.

The mapping portion 3 generates, with use of information of the detected light emitting part and the Max luminance output from the area active control/luminance stretch portion 4, a tone map to be applied to the input video signal.

The area active control/luminance stretch portion 4 outputs control data for controlling the backlight portion 6 to a backlight controller 5, and the backlight controller 5 controls luminance or light emitted from an LED or the backlight portion 6 for each of the divided areas based on the data. The luminance of the LSD in the backlight portion 6 is subjected to PWM (Pulse Width Modulation) control, and may be also subjected to current control or a combination thereof to be controlled so as to have a desired value.

Additionally, the area active control/luminance stretch portion 4 outputs control data for controlling a display portion 8 to a display controller 7, and the display controller 7 controls display on the display portion 8 based on the data. For the display portion 8, a liquid crystal panel illuminated by the LED in the backlight portion 6 is used for displaying an image.

The area active control/luminance stretch portion 4 stretches luminance of the backlight according to an average lighting rate to increase luminance of the LED in the backlight portion 6, then returning information of the luminance stretches to the signal processor 1 to lower luminance corresponding to the luminance stretch of the backlight portion 6. At the time, luminance stretching is applied to the entire backlight portion 6, and luminance in a part regarded as not emitting light excluding a light-emitting portion is lowered through video signal processing. This makes it possible to increase screen luminance only for a light emitting part to allow representation of a video with high contrast so that image quality can be improved. Note that, the controller of the present invention is provided for controlling the backlight portion 6 and the display portion 8, and corresponds to the signal processor 1, the area active control/luminance stretch portion 4, the backlight controller 5 and the display controller 7.

In the case of constituting the above-described display device as a television receiver, the television receiver is provided with means for selecting a broadcast signal received by an antenna to be demodulated, followed by decoding, for generating a video signal for reproduction, in which predetermined image processing is appropriately applied so the video signal for reproduction to be input as the input video signal of FIG. 1. This makes it possible to display the received broadcast signal on the display portion 8. The present invention can be configured as a display device and a television receiver provided with the display device.

Hereinafter, description will be given in more detail for a processing example of each portion of the present embodiment having the above-described configuration.

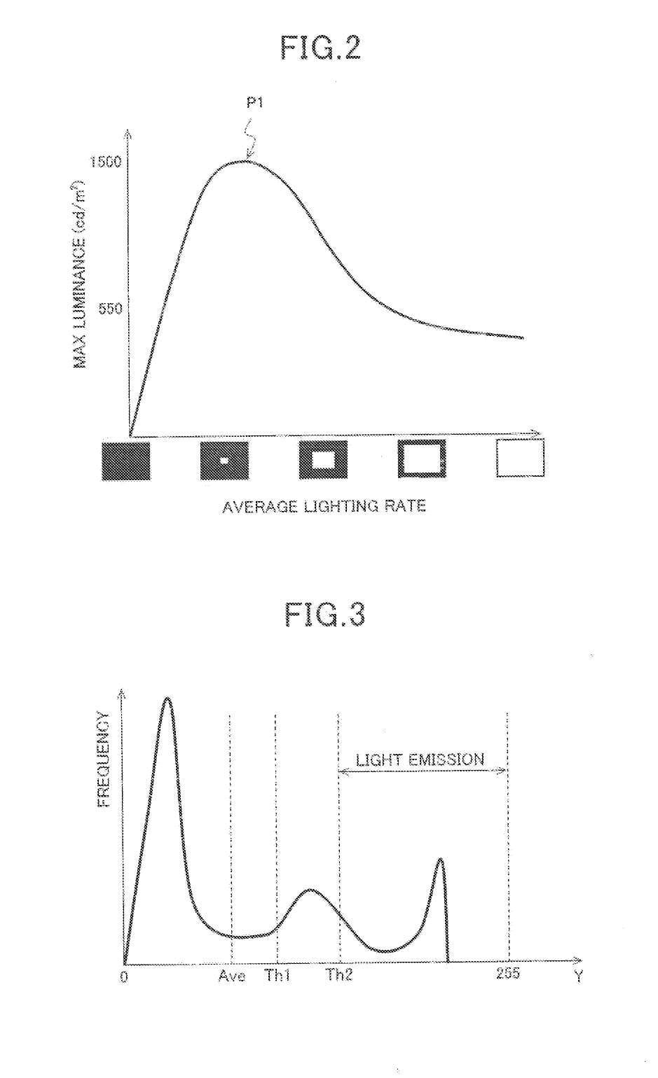

FIG. 2 is a diagram for explaining a processing example of the area active control/luminance stretch portion 4, Area-active control applied to the embodiment of the present invention is provided for dividing a video into predetermined multiple areas (areas) to control luminance or light emitted from an LED corresponding to the divided area for each of the areas. Here, the area active control/luminance stretch portion 4 divides one frame of a video into predefined multiple areas based on an input video signal to extract a maximum tone value of the video signal for each of the divided areas.

The area active control/luminance stretch portion 4 then decides a lighting rate of an LED for each area according to the extracted maximum tone value. For deciding the lighting rate of an LED, the lighting rate is lowered to lower luminance of the backlight for a dark area with a low maximum tone value. As an example, in a case where a tone value of a video is represented by 8-bit data from 0 to 255, when the maximum tone value is 128, luminance of the backlight is lowered to (1/(251/128)^{2.2}=0.217 times the luminance. Such area-active control processing is performed for defining an average lighting rate described below, and actual luminance of the backlight portion 6 is further stretched and strengthened based on a maximum luminance value decided according to the average lighting rate. Original reference luminance is, for example, luminance so as to have screen luminance of 550 (cd/m²) as a maximum tone value. The reference luminance is not limited to this example, and can be appropriately defined.

Further, the above-described lighting rate calculation method is an example, and a lighting rate is basically calculated according to a predefined operation expression in such a way as to lower luminance of a backlight for a dark low-tone area without lowering luminance of the backlight for a bright high-tone area.

A lighting rate is provided for defining an average lighting rate of the entire backlight, and can be represented as a ratio of a lighted area (window area) to an unlighted area. A lighting rate is 0 in a stats of having no lighted area, however, increases as a window of a lighted area becomes large, and reaches 100% when completely lighted.

The area active control/luminance stretch portion 4 calculates an average lighting rate of the entire screen from, the lighting rate decided according to a maximum tone value of each area. As areas with high lighting rates increase, the average lighting rate of the entire screen increases. Then, according to the relation as shown in FIG. 2, a possible maximum luminance value (Max luminance) is decided. A horizontal axis indicates a lighting rate of the backlight (window size), and a vertical axis indicates screen luminance (cd/m²) as Max luminance.

In FIG. 2, Max luminance when the backlight is completely lighted (average lighting rate of 100%) is provided as, for example, 550 (cd/m²). Then, in the present embodiment, as the average lighting rate is lowered, Max luminance is increased. At the time, pixels with the 255^{th} level tone value (in the case of 8-bit representation) has screen luminance which is the highest in a screen, resulting in attainment of possible maximum screen luminance (Max luminance). Therefore, it is found that screen luminance does not necessarily increase to Man luminance depending on a tone value of pixels even in the case of having the same average lighting rate.

When the average lighting rate reaches P1, the largest value of Max luminance is given, and at the time, maximum screen luminance is 1500 (cd/m²). In other words, in the case of reaching P1, possible maximum screen luminance is stretched to 1500 (cd/m²) compared to 550 (cd/m²) when completely lighted. P1 is set to a position having a relatively low average lighting rate. In other words, luminance of the backlight is stretched up to 1500 (cd/m²) in the case of having a low average lighting rate on a totally dark screen and having a part of a screen so as to have a high-tone peak. Moreover, a higher average lighting rate leads to luminance stretches of the backlight at a smaller degree since an originally bright screen appears more dazzlingly by excessively providing the luminance of the backlight, thus suppressing the degree of stretching.

From the maximum average lighting rate P1 to the average lighting rate 0 (perfect black) in Max luminance, the value of Max luminance is gradually lowered. A range having a low average lighting rate corresponds to a video on a dark screen, and the luminance of the backlight is suppressed to increase contrast rather than stretching the luminance of the backlight to increase screen luminance, so as to prevent from causing black float for maintaining display quality.

The area active control/luminance stretch portion 4 stretches luminance of the backlight according to the curve in FIG. 2, to output a control signal therefor to the backlight controller 5. Here, the average lighting rate changes according to a maximum tone value detected for each of the divided areas of a video as described above, and a luminance stretching state changes according to the average lighting rate.

A video signal input to the area active control/luminance stretch portion 4 is subjected to processing with the tone map generated through signal processing by the signal processor 1 described below to be input having a low-tone area with gain decreased. Thereby, in a non-light emitting area with a low tone, when the luminance of the backlight is stretched, the luminance is reduced according to a video signal, accordingly, resulting in enhanced screen luminance only in a light-emitting area so as to increase brilliance.

The area active control/luminance stretch portion 4 outputs the value of Max luminance obtained from an average lighting rate of the backlight according to the curve in FIG. 2 to the mapping portion 3 of the signal processor 1. The mapping portion 3 per forms tone mapping using Max luminance output from the area active control/luminance stretch portion 4.

Description will be given for the signal processor 1.

The light emission detector 2 of the signal processor 1 detects a light emitting part from a video signal. FIG. 3 shows an example of a Y histogram generated from a luminance signal Y of input video signals. The light emission detector 2 integrates the number of pixels for each luminance tone to generate the Y histogram for each frame of an input video signal. A horizontal axis indicates a tone value of luminance Y, and a vertical axis indicates the number of pixels integrated for each tone value (frequency). The luminance Y is one of feature quantities of a video for creating a histogram, and another example of the feature quantities will be described below. Here, the luminance Y is provided for detecting a light emitting part.

When the Y histogram is generated, an average value (Ave) and a standard deviation (σ) are calculated from the Y histogram, which are used for calculating two thresholds Th.

A second threshold Th2 is provided for defining a light-emitting boundary, and in the Y histogram, processing is performed for pixels which are greater than or equal to the threshold Th2 which are regarded as a light emitting part.

The second threshold Th2 is provided by:

Th2=Ave+Nσ expression (1)

N is a predetermined constant.

Additionally, a first threshold Th1 is set so as to reduce incongruity in tones of areas which are smaller than Th2 and the like, and provided by:

Th1Ave+Mσ expression (2)

M is a predetermined constant, and M<N.

The values of the first threshold Th1 and second threshold Th2 detected by the light emission detector 2 are output to the mapping portion 3 to be used for generation of a tone map.

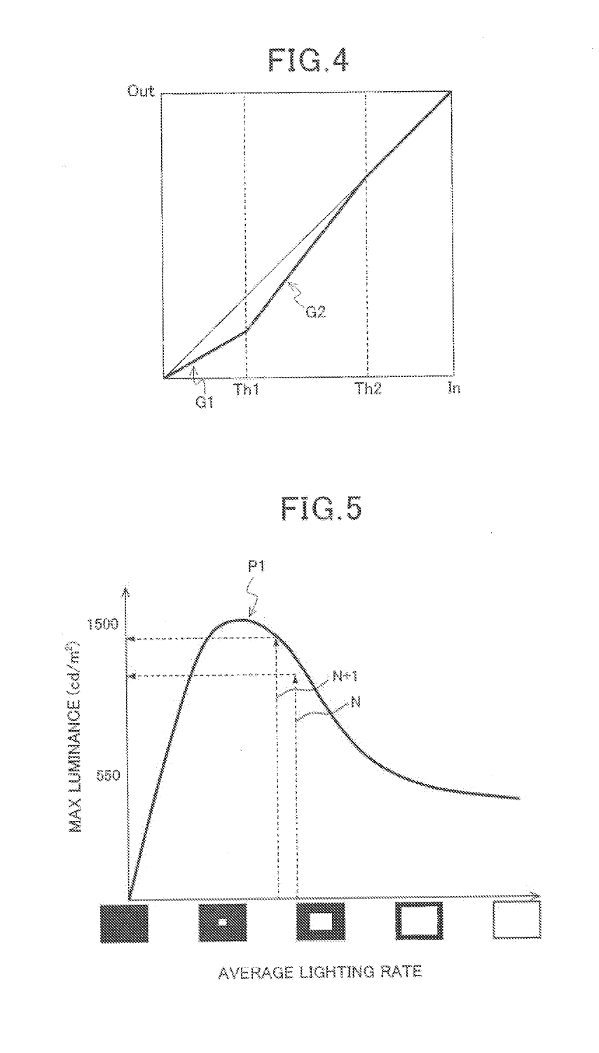

FIG. 4 is a diagram showing an example of a tone map generated by the mapping portion 3. A horizontal axis indicates an input tone and a vertical axis indicates an output tone, in a luminance value or a video. Pixels which are greater than or equal to the second threshold Th2 detected by the light emission detector 2 are regarded as a light emitting part in a video, and subjected to compression gain excluding a light emitting part for decreasing gain. At the time, when given compression gain is uniformly applied to an area which is smaller than Th2 as the light-emitting boundary to reduce the output tone, there is incongruity arising in tones. Therefore, the light emission detector 2 sets and detects the first threshold Th1 to set a first gain G1 for the area which is smaller than Th1, and sets a second gain G2 so as to linearly connect between Th1 and Th2 for performing tone mapping.

Description will be given for a method of setting gain.

To the mapping portion 3, the value of Max luminance is input from the area active control/luminance stretch portion 4. Max luminance indicates, as described above, maximum luminance defined from an average lighting rate of the backlight, and is input as a backlight duty value, for example.

The first gain G1 is applied to an area which is smaller than the first threshold Th1, and set by

G1=(Ls/Lm)^{1/V} expression (3)

Ls is reference luminance (reference luminance when luminance of the backlight is not stretched; luminance when maximum screen luminance becomes 550 cd/m², as an example), and Lm is max luminance output from the area active control/luminance stretch portion 4. Therefore, the first gain G1 to be applied to the area which is smaller than the first threshold Th1 lowers an output tone of a video signal so as to reduce an increment of screen luminance by stretching of luminance of the backlight.

In tone mapping for the second threshold Th2 or higher, f(x)=x. That is, having input tone=output tone, processing for lowering the output tone is not performed. Connection between the first threshold Th1 and the second threshold Th2 is set so as to linearly connect between an output tone of the first threshold Th1 that is lowered by the first gain G1 and an output tone of the first threshold Th1.

That is, the second gain G2 is decided by G2−(Th1−G1·Th2;)/(Th1−Th2).

By the above-described processing, the tone map as shown in FIG. 4 is obtained. At the time, for a connecting part between Th1 and Th2, a predetermined range (for example, connecting part±Δ (Δ is a predetermined value)) may be subjected to smoothing by a quadratic function.

Processing with the tone map generated by the mapping portion 3 is applied to input video signals, in which the video signal whose low-tone part is output less based on an amount of luminance stretches of the backlight is input to the area active control/luminance stretch portion 4.

FIG. 5 is a diagram for explaining Max luminance output from the area active control/luminance stretch portion 4.

The area active control/luminance stretch portion 4 inputs a video signal subjected to the processing with the tone map generated by the mapping portion 3 to perform area-active control based on the video signal for deciding Max luminance based on an average lighting rate. At the time, a frame is an N frame. The value of Max luminance of the N frame is output to the mapping portion 3 of the signal processor 1. The mapping portion 3 generates the tone map as shown in FIG. 4 using the input Max luminance of the N frame to be applied to a video signal of an N+1 frame.

In this way, in the present embodiment, Max luminance based on an area-active average lighting rate is feedback to be used for tone mapping for a next frame. The mapping portion 3 applies gain for lowering video output for the area which is smaller than the first threshold Th1 (first gain G1) based on the Max luminance decided in the N frame. The second gain G2 for linearly connecting between Th1 and Th2 is applied to an area between Th1 and Th2 to lower video output between Th1 and Th2.

Because gain for lowering video output is applied to the N frame, in an area having a high lighting rate in which an average lighting rate is greater than or equal to P1, the N+1 frame has a trend that a maximum tone value for each area lowers so that a lighting rate lowers, and thereby has a trend that Max luminance increases. This causes a trend that an amount of luminance stretches of the backlight is further increased to increase brilliance on a screen. Such a trend is, however, not found in an area having a lighting rate lower than P1, indicating an opposite trend thereto.

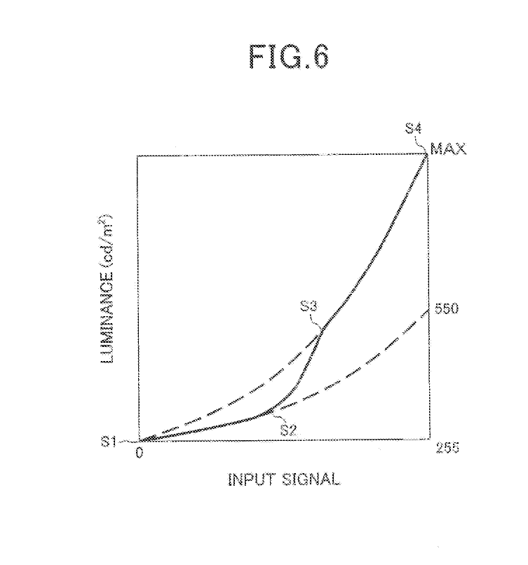

FIG. 6 is a diagram showing a state where screen luminance is enhanced through processing by the area active control/luminance stretch portion 4. A horizontal axis indicates a tone value of an input video signal, and a vertical axis indicates screen luminance (cd/m²) of the display portion 8.

S2 and S3 correspond to positions of the tone values of the first threshold Th1 and second threshold Th2 used by the light emission detector 2, respectively. In the area which is greater than or equal to the second threshold Th2 detected by the light emission detector 2 as described above, signal processing is not performed for lowering an output tone of a video signal according to an amount of luminance stretches of the backlight. As a result, from S3 to S4, an input video signal is enhanced and displayed by a γ curve according to Max luminance decided by area-active control.

For example, in a case where Max luminance is 1500 (cd/m²), when an input video signal is an upper limit maximum tone value (255), screen luminance reaches 1500 (cd/m²).

On the other hand, input tone values from S1 to S2 are displayed on a screen, as described above, by the γ curve based on reference luminance since the first gain G1 is applied to a video signal in such a way as to reduce an increment of screen luminance by stretching of luminance of the backlight. Such the display is caused by reducing am output value of a video signal so as to fall within a range of values smaller than the threshold Th1 (corresponding to S2) in such a way as to correspond to luminance stretches in the mapping portion 3, according to Max luminance decided in the area active control/luminance stretch portion 4. From S2 to S3, screen luminance transits according to tone mopping from Th2 to Th1.

As Max luminance becomes larger, there is a larger difference of screen luminance orientations between a curve based on reference luminance from S1 to S2 and a curve based on Max luminance from S3 to 34. The curve based on the reference luminance is, as described above, the γ curve in which screen luminance of a maximum tone value becomes the reference luminance when luminance of the backlight is not stretched (screen luminance of a maximum tone value is 550 cd/m², as an example), while a curve based on Max luminance is the γ curve in which screen luminance of a maximum tone value becomes the Max luminance decided by the area active control/luminance stretch portion 4.

In this way, between a 0-tone (S1) to S2 of an input video signal, screen luminance is controlled according to reference luminance. A dark video with a low tone, in the case of being displayed with increased luminance, has lowered contrast and deteriorated quality such as having black float, and screen luminance is thus not increased by reducing luminance by luminance stretches of the backlight by video signal processing.

Since a range covering S3 or higher of input video signals corresponds to a range regarded as emitting light, the video signal is retained without being suppressed in a state where the backlight is stretched by luminance stretching. Thereby, screen luminance is enhanced to allow display of a more brilliant high-quality image. Note that, the γ curve from S1 to S2 does not necessarily conform to the reference luminance, and can be set by appropriately adjusting the gain G1, having a level allowing a difference from an enhanced area of a light emitting part.

### Embodiment 2

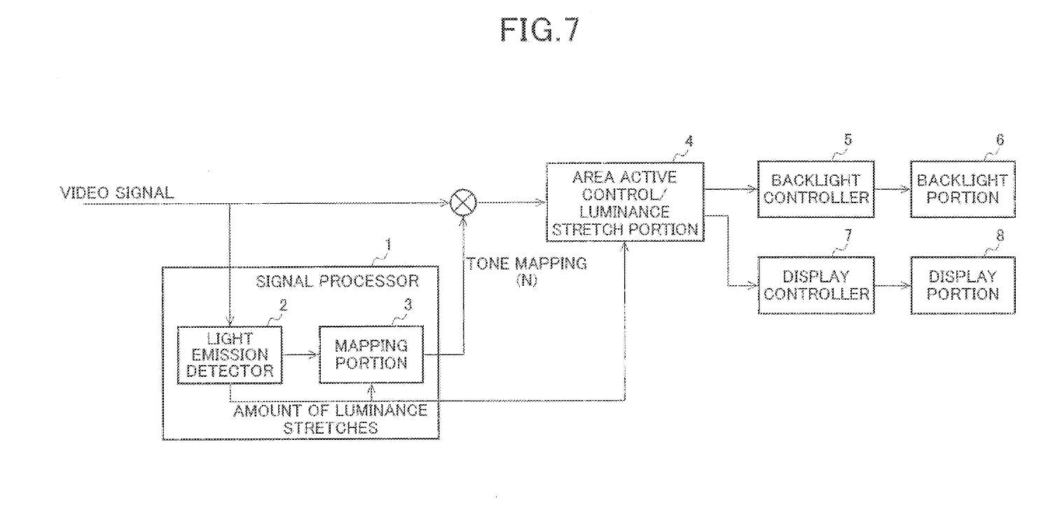

FIG. 7 is a diagram explaining another embodiment of the video display device according to the present invention.

A second embodiment has the same configuration as the first embodiment but having an only difference from the first embodiment that a luminance stretch is decided based on detection by the light emission detector 2 without deciding a value of Max luminance used for performing tone mapping by the area active control/luminance stretch portion 4, to execute tone mapping based on the decided luminance stretch. Therefore, at the mapping portion 3 of the signal processor 1, it does not need to output the value of Max luminance by luminance stretches from the area active control/luminance stretch portion 4 as with Embodiment 1.

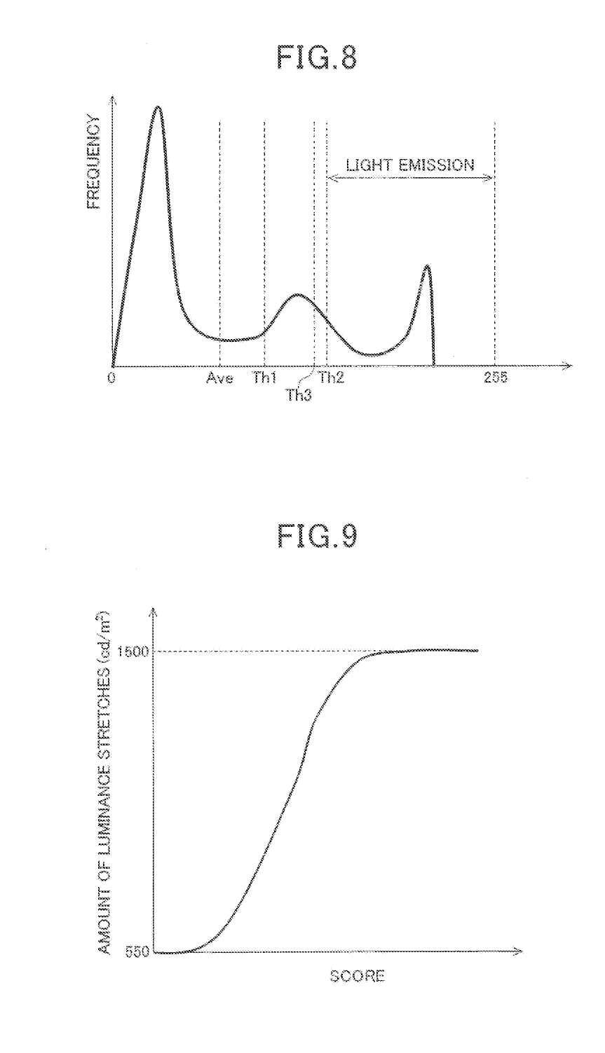

FIG. 8 is a diagram showing an example of a Y histogram generated from a luminance signal Y of input video signals. As with Embodiment 1, the light emission detector 2 integrates the number of pixels for each luminance tone to generate the Y histogram for each frame of an input video signal. Then, the average value (Ave) and the standard deviation (σ) are calculated from the Y histogram, those of which are used to calculate two thresholds Th1 and Th2. As with Embodiment 1, the second threshold Th2 is given for defining a light-emitting boundary, and pixels which are greater than or equal to the threshold Th2 in the Y histogram are regarded as a light emitting part.

In the present embodiment, a third threshold Th3 is further set. The third threshold Th3 is placed between Th1 and Th2, for detecting a state of pixels of a light emitting part.

The threshold Th3 may be provided as the same value as Th2, however, having a somewhat large margin for a light emitting part which is greater than or equal to Th2 so as to easily perform processing.

Therefore, Th3=Ave+Qσ (M<Q≦N).

FIG. 9 is a diagram showing a setting example of luminance stretches according to pixels which are greater than or equal to the third threshold Th3. A horizontal axis indicates a score of pixel values which are greater than or equal to the threshold Th3, and a vertical axis indicates an amount of luminance stretches according to the score.

The score demonstrates the degree of brightness by counting the number of pixels having a tone value which is greater than or equal to the third threshold Th3 to calculate a weighted distance from the threshold Th3, and for example, is calculated by: Score=1000×Σcount[i]×(i^{z}−Th3²)/(Σcount[i]×Th3²). Σcount[i] means to integrate by counting the number of pixels with respect to a tone value i. Therefore, increased high-tone pixels away from Th3 in a light emitting part give a higher score. Furthermore, even in the case of constantly having the number of pixels which are greater than or equal to Th3, high-tone pixels give a higher score.

In the case of having a score in a certain level or higher, an increased amount of luminance stretches Is set to increase brilliance by applying higher-luminance stretching to a brilliant high-tone video. In this example, in a part having a certain level or higher score, possible maximum screen luminance reached after luminance stretching is set to 1500 (cd/m²). Moreover, a part having a low score is set so that an amount of luminance stretches becomes small as a score becomes small.

The amount of luminance stretches with the same concept as Max luminance of the first embodiment is indicated by, for example, a backlight duty value.

The amount of luminance stretches decided according to the values of the first threshold Th1 and the second threshold Th2 detected by the light emission detector 3 and scores of pixels which are greater than or equal to Th3 are output to the mapping portion 3 to be used for generation of a tone map.

Tone mapping processing in the mapping portion 3 is provided the same as the first embodiment. That is, as shown in FIG. 4, the first gain G1 is set to an area which is smaller than Th1 detected by the light emission detector 2, and the second gain G2 is set in such a way as to linearly connect between Th1 and Th2. At the time, for setting the gain G1, the amount of luminance stretches detected by the light emission detector 2 is used to lower luminance by video signal processing according to an amount of luminance stretches of the backlight.

The obtained tone map is applied to processing of an input video signal to be input to the area active control/luminance stretch portion 4.

The processing by the area active control/luminance stretch portion 4 is provided the same as Embodiment 1. However, the area active control/luminance stretch portion 4 does not need to decide Max luminance from an average lighting rate of the backlight to be output to the signal processor 1 as with Embodiment 1, and to the contrary, stretches luminance of an LED of the backlight portion 6 based on the amount of luminance stretches detected by the light emission detector 2 of the signal processor 1.

That is, the area active control/luminance stretch portion 4 divides a video into predetermined multiple areas (areas) to extract a maximum tone value of a video signal for each of the divided areas, and decides a lighting rate of an LED for each area according to the extracted maximum tone value. For example, for a dark area with a low maximum tone value, the lighting rate is lowered to lower luminance of the backlight. Then, electricity powered to the entire backlight is increased according to an amount of luminance stretches in this state to entirely increase luminance of the backlight. Thereby, a bright light-emitting video is shown brighter with increased brilliance. Moreover, in a non-light emitting part, luminance corresponding to luminance stretches by video signal processing is reduced, resulting in higher luminance attained only in a light emitting part on a screen, so that a high-quality video with high contrast can be displayed. The relation between an input video signal and screen luminance is provided the same as FIG. 6 shown in the first embodiment.

### Embodiment 3

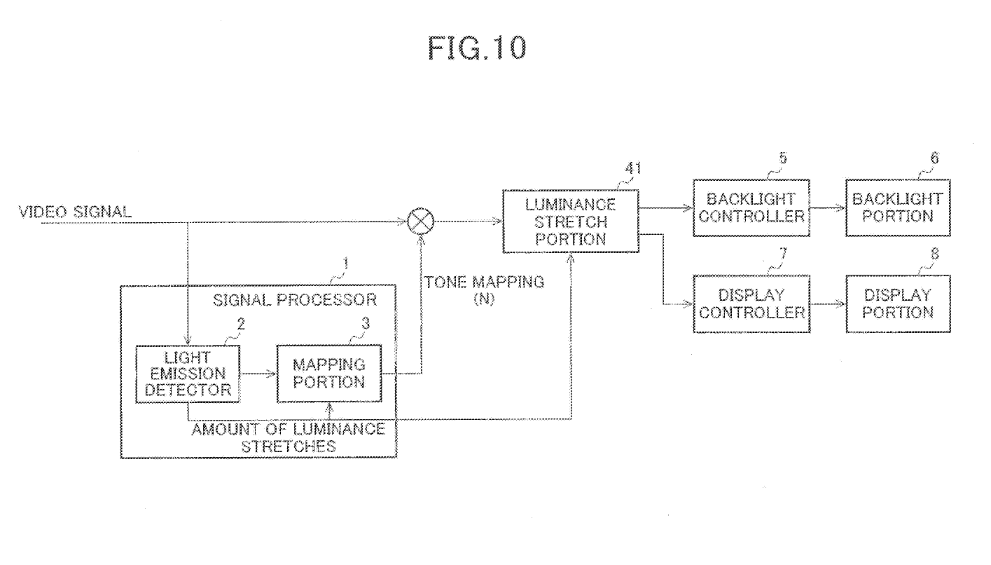

FIG. 10 is a diagram explaining still another embodiment of the video display device according to the present invention.

A third embodiment has the same configuration as the second embodiment for performing the same operation as the second embodiment, but having an only difference from the second embodiment that a luminance stretch portion 41 stretches luminance of the backlight portion 6 based on the amount of luminance stretches output from the mapping portion 3 of the signal processor 1 without performing area-active control.

That is, the luminance stretch portion 41 inputs a video signal subjected to processing with the tone map generated by the mapping portion 3 to output control data displaying the video signal to the display controller 7. At the time, area-active control processing is not performed. On the other hand, the entire backlight portion 6 is uniformly stretched based on the amount of luminance stretches output from the mapping portion 3.

Thereby, a bright light-emitting video is shown brighter with increased brilliance. Moreover, in a non-light emitting part, luminance corresponding to luminance stretches by video signal processing is reduced, resulting in higher luminance attained in a light emitting part on a screen, so that a high-quality image with high contrast can be displayed.

Operation for other components in the third embodiment is the same as the second embodiment, thus omitting repeated explanation.

### Another Feature Quantity

In the above-described respective examples, in processing for detecting a light-emitting portion by the light emission detector 2, with use of the luminance Y as a feature quantity of a video, a luminance histogram is generated to detect a light-emitting portion from the histogram. As the feature quantity for generating the histogram, in addition to luminance, for example, a CMI (Color Mode Index) or MaxRGB can be used.

The CMI in an index indicating bow bright a focused color is. Here, the CMI is different from luminance and indicates brightness also adding color information. The CMI is defined by

L*/L*modeboundary×100 expression (4).

The above-described L* is an index of relative brightness of a color, and L*=100 gives lightness of the brightest unite as an object color. In the above-described expression (4), L* indicates lightness of a focused color, and L*modeboundary is a lightness of a boundary appearing like emitting light with the same chromaticity as the focused color. Here, it is found that lightness is given as: L*modeboundary≈Optimal color (brightest color of object colors). Lightness of a color given as CMI=100 is referred to as a light-emitting color boundary, and defined that light is emitted when exceeding CMI=100.

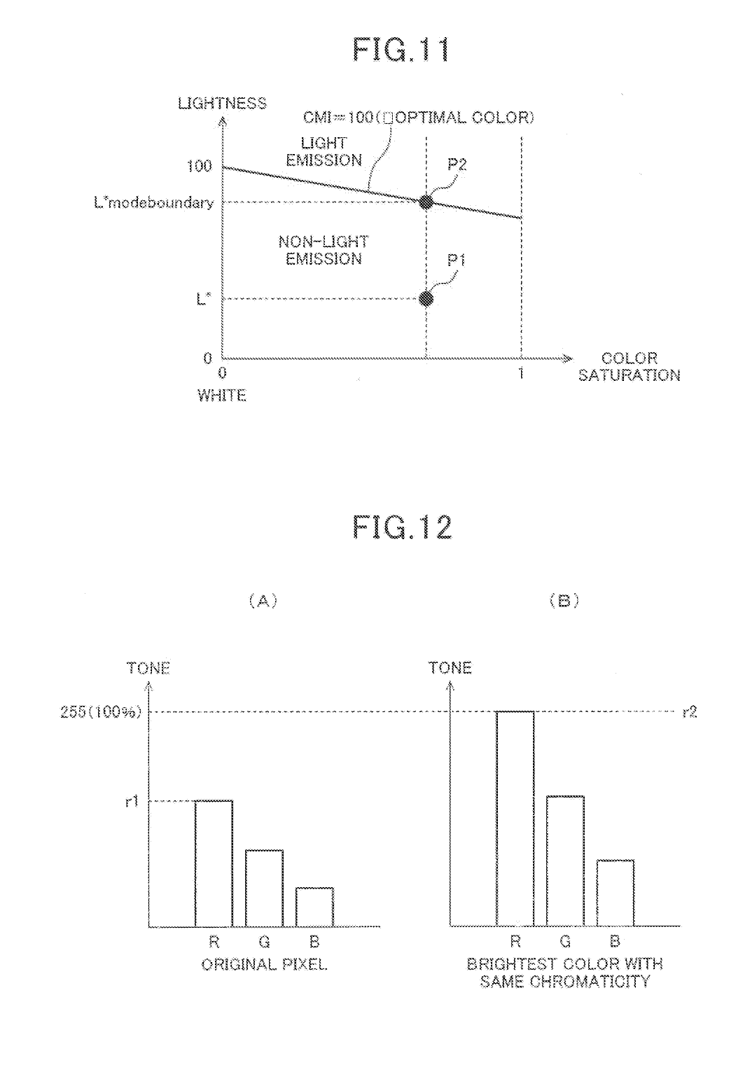

A method of calculating the CMI from a broadcast video signal to be displayed on the video display device will be described with reference to FIG. 11. A broadcast video signal is standardized to be transmitted based on the BT. 709 standard. Therefore, first, RGB data of a broadcast video signal is converted to data of a tristimulus value XYZ using a conversion matrix conforming to the BT. 709 standard. Then, the lightness L* is calculated using a conversion equation from Y. It is assumed that L* of the focused color is present at a position P1 of FIG. 11. Chromaticity is then calculated from the converted XYZ to examine L* of an optimal color with the same chromaticity as the focused color L*modeboundary) from known data of the optimal color, which is positioned at P2 in FIG. 11.

From these values, the CMI is calculated using the above-described expression (4). The CMI is indicated by a ratio of L* of a focused pixel to L* of an optimal color with the same chromaticity (L*modeboudary).

The above-described method is used for obtaining the CMI for each pixel of a video signal. With the standardized broadcast signal, all pixels take any one of the CMIs falling within a range 0 to 100. Then for one frame of a video, a CMI histogram is created with as horizontal axis given as a CMI and a vertical axis given as frequency. Here, the average value Ave. and the standard deviation σ are calculated to set each threshold for detecting a light emitting part.

Further, in another example, a feature quantity is data having a maximum tone value of RGB data (Max RGB). Having two colors with the same chromaticity in a combination of RGB means the same as that a ratio of RGB is not changed. That is, processing for operating an optimal color with the same chromaticity in the CMI is processing for obtaining a combination of RGB having the largest tone of RGB data when the ratio of RGB data is not changed to be multiplied by a fixed number.

For example, a pixel having RGB data with a tone as indicated in FIG. 12(A) is a focused pixel. When RGB data of the focused pixel is multiplied by a fixed number, a color when any of RGB is first saturated is the brightest color with the same chromaticity as an original pixel, as shown in FIG. 12(B). Then, when a tone of the focused pixel of the color which is first saturated (in this case, R) is r1, and a tone of R of an optimal color is r2, the value similar to the CMI can be obtained by

r1/r2×100 expression (5).

The color which is first saturated when RGB is multiplied by a fixed number is a color having a maximum tone of RGB of the focused pixel.

The value by the above-described expression (5) for each pixel is then calculated to create a histogram. The average value Ave. and the standard deviation σ are calculated from this histogram to set each threshold so that a light emitting part can be detected.

### EXPLANATIONS OF LETTERS OR NUMERALS

1 . . . signal processor; 2 . . . light emission detector; 3 . . . mapping portion; 4 . . . area active control/luminance stretch portion; 5 . . . backlight controller; 6 . . . backlight portion; 7 . . . display controller; 8 . . . display portion; and 41 . . . luminance stretch portion.

1.-9. (canceled)

10. A video display device, comprising:
a display portion for displaying an input video signal;
a light source for illuminating the display portion; and
a controller for controlling the display portion and the light source, wherein
the controller detects, based on a histogram of a predetermined feature quantity of the input video signal, an upper area in a predetermined range of the histogram, and
enhances display luminance of the upper area in the predetermined range by stretching luminance of the light source to be increased and lowering luminance of a video signal in areas excluding the upper area in the predetermined range.

11. The video display device as defined in claim 10, wherein
the controller divides an image generated from an input video signal into a plurality of areas, changes a lighting rate of an area of the light source based on a tone value of a video signal in the divided area, and
stretches the luminance of the light source based on an average lighting rate of all the areas.

12. The video display device as defined in claim 11, wherein
the controller defines in advance a relation between the average lighting rate and possible maximum luminance on a screen of the display portion, and stretches the luminance of the light source based on the maximum luminance defined according to the average lighting rate.

13. The video display device as defined in claim 10, wherein
the controller by counting the number of pixels to each of which brightness is weighted for a video in a predetermined range including the detected upper area in the predetermined range, thereby calculates a score indicating a degree of brightness, and stretches the luminance of the light source according to the score.

14. The video display device as defined in claim 13, wherein
the controller divides an image generated from the input video signal into a plurality of areas, changes a lighting rate of an area of the light source based on a tone value of a video signal in the divided area, and stretches luminance according to the score with respect to the changed lighting rate.

15. The video display device as defined in claim 10, wherein
the controller determines an area which is greater than or equal to
thresh=A+Nσ (N is a constant)
as the upper area in the predetermined range, when A is an average value and σ is a standard deviation of the histogram, respecting.

16. The video display device as defined in claim 10, wherein
the controller reduces an increase in display luminance of the display portion due to a stretch of luminance of the light source according to a decrease in luminance of the video signal in a predetermined area where the feature quantity is low.

17. The video display device as defined in claim 12, wherein
the controller executes, for each frame of an input video signal, stretching of the luminance of the light source based on the average lighting rate and lowering luminance of a video signal in an area excluding the upper area in the predetermined range detected from the histogram, and wherein
the histogram of each frame is obtained from a video with a lowered luminance of a video signal excluding the upper area in the predetermined range in a frame before the histogram is generated.

18. A television receiver including the video display device as defined in claim 10.
